(19) United States
(12) Patent Application Publication
(10) Pub. No.: US 2007/0056171 A1
(43) Pub. Date: Mar. 15, 2007

(54) CVD diamond cutter wheel

(76) Inventor: Jonathan Taryoto, Hong Kong (CN)

Correspondence Address: Jonathan Taryoto, 3A Hatton House, 15 Kotewall Road, Hong Kong, CN

(21) Appl. No.: 11/222,830

(22) Filed: Sep. 12, 2005

(51) Int. Cl. B26B 9/00

(52) U.S. Cl. 30/350

(57) ABSTRACT

A cutter wheel for use in pipe cutting or scoring refractory materials comprises an annular disk CVD diamond capable of forming deeper and smoother slit at faster cutting speed.

### BACKGROUND OF THE INVENTION

1) Field of the Invention

This invention relates to a cutter wheel comprising an annular disk CVD diamond for forming scribe lines on refractory materials including semiconductor wafer as well as cutting elongated tubular metals.

In this disclosure, the phrase “diamond” or “CVD diamond” is intended to cover diamond that is formed by the chemical vapor deposition method.

2) Description of Prior Art

It is common in the art to sever glass by scribing its surface with a blunt edged wheel made of hard material, e.g., high speed steel, cemented carbide alloy or sintered diamond. Metal pipes and tubes are cut using larger diameter cutter wheel currently available only in limited metal alloys which are far less wear resistance than diamond.

Grinding and drilling solid polycrystalline diamond compact (PDC) is time consuming and costly. The hardness of PDC and geometry of a cutter wheel prevent its processing with conventional grinder. According to a literature from Microcut Ltd. of Switzerland, a 2.5 mm diameter polycrystalline diamond cutter wheel will require between 15 to 30 minutes to grind the cutting edge with its MicroCenter 31. A purpose built machine e.g., Corbore 125 to bore the center axle hole. Additionally it is anticipated that the 2.5 mm PDC diameter blank will have to be cut from a lager blank aforementioned drilling and grinding process.

Multiple layer polycrystalline diamond compact have been disclosed in U.S. Pat. No. 4,627,503 issued to Duane Horton for drilling holes. This center layer polycrystalline diamond comprises metallic binders, whereas CVD diamond does not contain binder material, it possesses advantages over PDC in terms of greater hardness and wear resistance. In many application CVD diamond tooling is said to demonstrate tool life two to three times that of PDC.

Recent improvement in cutter wheel with modified cutting edge or center bore on high speed steel or cemented carbide were disclosed in U.S. Pat. Nos. 6,796,212, 6,065,215 and 5,836,229, such cutter wheel requires precision machining process to generate the jagged edge or complex shape mounting hole on the cutter wheel. Thus the costly production problem is not suppressed. U.S. Pat. Nos. 5,855,974 to Wu et al. teaches coating of preformed cutter wheel with CVD diamond to improve its wear resistance. The preform wheel comprising tungsten carbide and its pretreatment of this substrate prior to the coating process is undesirably costly. Additionally, regrinding CVD diamond coated tool is unusable.

### SUMMARY OF THE INVENTION

In accordance with the present invention, a cutter wheel for pipe cutting or scribing refractory materials, comprising a center layer CVD diamond in adequate thickness which may be within 10 to 200 μm having predetermine cutting angle of of the scribing wheels to within the range of 90° to 165° to define the peripheral ridge.

An object of the present invention is to provide a economically feasible method and means of providing a diamond cutter wheel which is easily and efficiently manufactured to alleviate the problem associated with prior art processing method. It is a further object of the present invention to provide a diamond cutter wheel which is durable and in a substantially larger diameter than previously feasible.

The foregoing and other objects and advantages of this invention will appear in the cited claims and the following description, taken in connection with the accompanying drawings of a preferred embodiment.

### BRIEF DESCRIPTION OF THE DRAWINGS

In the annexed drawings:

FIG. 1 is a front view of a cutter wheel embodying the invention;

FIG. 2 is a side view of the cutter wheel shown in FIG. 1;

FIG. 3 is a front view of a preassemble cutter wheel;

FIG. 4 is a side view of a CVD diamond annular ring;

FIG. 5 is a front view of a cutter wheel with integral shaft;

FIG. 6 is a front view of a cutter wheel comprising a center layer CVD diamond;

FIGS. 6A to 6D are exaggerated diagrams showing different shapes of peripheral edges in accordance with the present invention.

FIG. 7 is a front view of a cutter wheel with single side support;

FIGS. 7A to 7D are exaggerated diagrams showing different shapes of peripheral edges of single side support in accordance with the present invention.

### DETAILED DESCRIPTION OF THE INVENTION

The following is a description and discussion with reference to the drawings. It should be noted that such discussion and description is not meant to unduly limit the scope of the invention. It will also become apparent that the cutter wheel of the present invention may be utilized for specific uses as well as performing other cutting application on various materials and readily recognize to those skilled in the art.

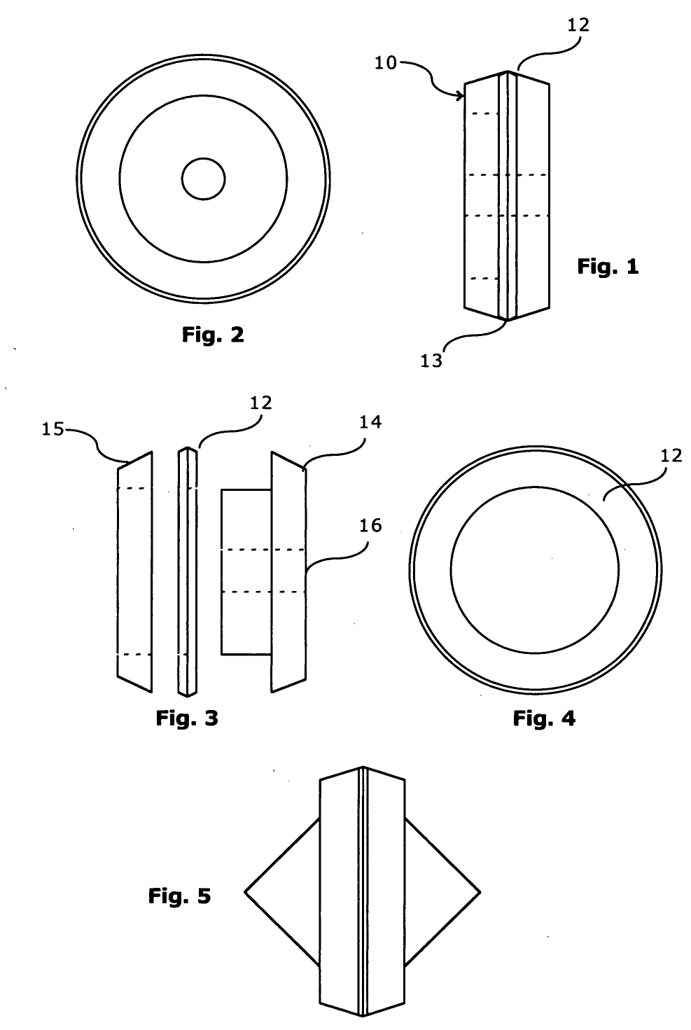

FIG. 1 shows a front view of the cutter wheel 10 of the present invention. The cutter wheel 10 comprises a chemical vapor deposition diamond center layer 12 forming the cutting line 13 at an angle of approximately 160°, bonded to a right side hub 14 and a left side portion 15. Alternatively, the center layer 12 can comprise a monocrystalline diamond as formed by the CVD process.

Free standing or substrate supported CVD diamond film is available from P1 Diamond Inc., in various thickness from a few micron up to 1 mm in thickness. Whereas CVD diamond is grown in sheets, its thickness is containable to a height sufficient to attain the required thickness of the cutting edge, accordingly minimizing both material and processing cost. This CVD diamond film is laser cut into an annular ring 12 as shown in FIG. 4 using conventional Nd:YAG laser cutting machine. The right side preformed hub 14 is formed from preferably a metallic material. The left side preformed flange 15 is provided from compatible material that readily bond to the right side hub 14 affixed by brazing, shrink fit, or conventional bonding method with resin well know in the art. For substrate supported CVD diamond (not shown) the shrink fit method of attachment to the right side hub 14 may be adequate for small diameter wheel.

In general, a thicker glass requires larger diameter wheel and higher scoring pressure to effect deeper fissure in the glass material. In this cutter wheel of the present invention, it is more preferable that the cutter wheel has integral shaft in the shape shown in FIG. 5, that minimize axle friction and failure at relatively high pressure scoring operation.

As is apparent, the scoring of refractory material using cutter wheel is to cause an indentation on the surface and fracture below the indentation along the line of scribe and it has not been unusual to use a relatively blunt scribing wheel. The inherent hardness of CVD diamond that surpass PDC ensures the cutting performance and edge retention albeit at greater pressure exerted upon the wheel.

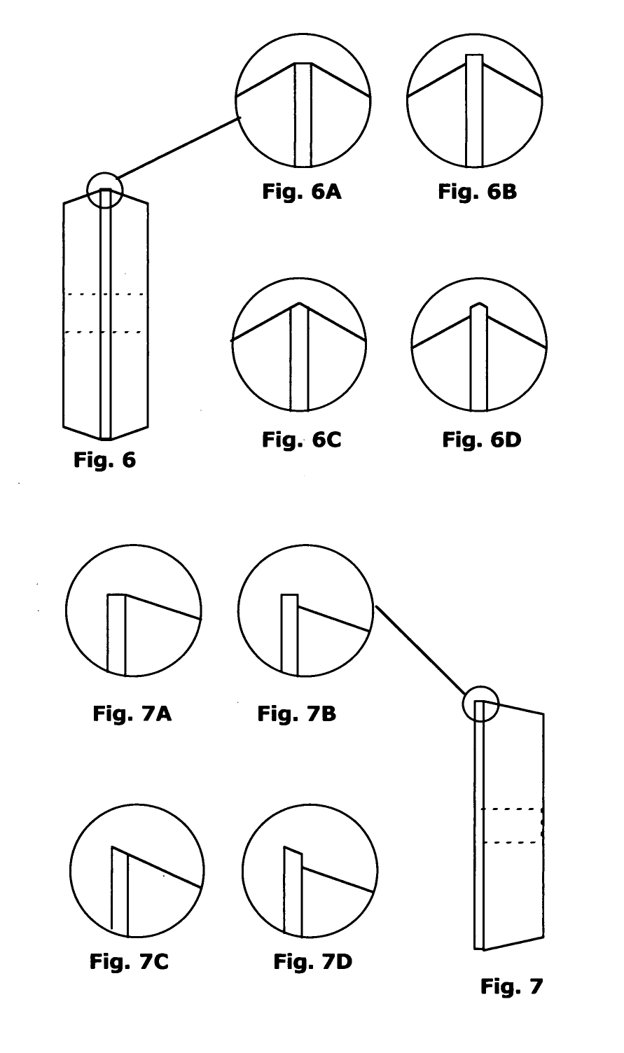

As is well known, diamond is difficult to polish, however, in most application the surface roughness left by the laser or EDM cutting at the peripheral edge has minimized slipping of the cutter wheel relative-to the plate glass. A cutter wheel in accordance with this preferred embodiment is formed with flat peripheral ridge as shown in FIG. 6A.

Electrically conductive CVD diamond is also widely available. This feature provides further opportunity for lower processing cost using traditional electro discharge machining technique well known in the art of processing PDC tool.

A cutter wheel in accordance with this preferred embodiment of the present invention may include without limitation scribing of semiconductor wafer, and may advantageously be used for cutting elongated tubular material by means of different sizes and configurations of the cutter wheels as shown in FIG. 7.

I claim:

1. A cutter wheel comprising a center layer annular CVD diamond disc less than 1.0 mm in thickness, said disc having an inner and an outer diameter and, a wheel body having a hub portion and an integral peripheral flange each attached to opposite sides of said central diamond disc.

2. A cutter wheel as claimed in claim 1, wherein said CVD diamond periphery edge cutting angle is from 90°to 180°.

3. A cutter wheel according to claim 1 wherein said CVD diamond is monocrystalline.

4. A cutter wheel according to claim 1 wherein said CVD diamond is polycrystalline.

5. A cutter wheel as claimed in claim 1, wherein said CVD diamond disk is free standing.

6. A cutter wheel as claimed in claim 1, having a diameter of from 1 mm to 65 mm.

7. A cutter wheel according to claim 1 wherein said CVD diamond is electrically conductive.

8. A cutter wheel according to claim 1 wherein said CVD diamond is electrically non conductive.

9. A cutter wheel according to claim 1 wherein said wheel has a center axle hole.

10. A cutter wheel as claimed in claim 1, wherein said wheel has an integral shaft.

11. A cutter wheel for scribing refractory material to facilitate breakage along such scribed line, said cutter wheel comprises a CVD diamond disc less than 0.5 mm in thickness, having an integral substrate of cemented carbide support layer and said wheel being formed with a center axle hole.

12. A cutter wheel as claimed in claim 10, wherein said CVD diamond is polycrystalline.

13. A cutter wheel as claimed in claim 10, wherein said CVD diamond is monocrystalline.

14. A cutter wheel as claimed in claim 10, having a diameter of from 1 mm to 15 mm.

15. A cutter wheel as claimed in claim 10, wherein said CVD diamond is electrically conductive.

16. A cutter wheel as claimed in claim 10, wherein said CVD diamond is electrically non conductive.

17. A cutter wheel as claimed in claim 10, wherein said cemented carbide layer is beveled toward the periphery forming an acute angle.

18. A cutter wheel as claimed in claim 16, wherein said angle is from 30° to 90°.
